(19) United States
(12) Patent Application Publication
(10) Pub. No.: US 2017/0171688 A1
(43) Pub. Date: Jun. 15, 2017

(54) Mobile Phone Change Method and Electronic Device

(71) Applicants: Le Holdings (Beijing) Co., Ltd., Beijing (CN); Lemobile Information Technology (Beijing) Co., Ltd, Beijing (CN)

(72) Inventor: Kaiyue Deng, Beijing (CN)

(21) Appl. No.: 15/241,577

(22) Filed: Aug. 19, 2016

Related U.S. Application Data
(63) Continuation of application No. PCT/CN2016/088577, filed on Jul. 5, 2016.

(30) Foreign Application Priority Data
Dec. 15, 2015 (CN) 201510934855.6

(51) Int. Cl. H04W 4/00; H04M 1/725

(52) U.S. Cl. CPC H04W 4/001; H04M 1/72544

(57) ABSTRACT

Disclosed are a mobile phone change method and an electronic device. The method includes: starting a mobile phone change task when a mobile phone change trigger signal is monitored; displaying a mobile phone change page; starting a game task when a game start trigger signal is monitored during execution of the mobile phone change task; replacing the mobile phone change page with a game page containing game content; quitting the game task when a game quit trigger signal is monitored during execution of both the mobile phone change task and the game task; and replacing the game page with the mobile phone change page. According to the mobile phone change method and electronic device of the present disclosure, other operations can be performed during mobile phone change, thereby improving the mobile phone utilization rate, preventing users from having a sense of anxiety because of long waiting time during waiting for mobile phone change, and providing a relaxing and pleasant usage environment for users.

### CROSS REFERENCE TO RELATED APPLICATIONS

This application is a continuation of International Application No. PCT/CN2016/088577, filed on Jul. 5, 2016, which is based upon and claims priority to Chinese Patent Application No. 201510934855.6, filed on Dec. 15, 2015, titled “Mobile Phone Change Method and Device”, the entire contents of which are incorporated herein by reference.

### TECHNICAL FIELD

The disclosure relates to the technical field of methods for transferring data between mobile phones, and particularly relates to a mobile phone change method and an electronic device.

### BACKGROUND

With the popularization of smart mobile phones, the frequency for users to change mobile phones becomes higher and higher. In order not to lose or deplete information stored in mobile phones when mobile phones are changed each time, a large number of tools, i.e. APPs with the main concept of mobile phone change appear in the market at present. These mobile phone change tools can quickly transfer data in the types of address lists, short messages, pictures, music and the like to a new mobile phone.

However, 5-10 minutes are needed when these mobile phone change APPs in the market per mobile phone change, and other programs cannot be executed when mobile phone change is executed. Thus, within this time period of mobile phone change, the mobile phone can only stay on the mobile phone change page, so that other functions of the mobile phone cannot be used, resulting in lower utilization rate of the mobile phone within this time period.

### SUMMARY

The present disclosure provides a mobile phone change method and an electronic device. According to the mobile phone change method and the electronic device of the present disclosure, other task operations can be performed during mobile phone change, thereby improving the mobile phone utilization rate, preventing users from having a sense of anxiety because of long waiting time during waiting for mobile phone change, and providing a relaxing and pleasant usage environment for users.

One objective of the embodiments of the present disclosure is to provide a mobile phone change method, comprising the following steps:

starting a mobile phone change task when a mobile phone change trigger signal is monitored;

displaying a mobile phone change page;

starting a game task when a game start trigger signal is monitored during execution of the mobile phone change task;

replacing the mobile phone change page with a game page containing game content;

quitting the game task when a game quit trigger signal is monitored during execution of both the mobile phone change task and the game task; and

replacing the game page with the mobile phone change page.

Preferably, if the game quit trigger signal is a temporary game quit trigger signal, the quitting the game task comprises: saving current game information in a local database; and ending the process of the game task; or

if the game quit trigger signal is a game task completion trigger signal, the quitting the game task comprises: ending the process of the game task.

Preferably, the mobile phone change method further comprises the following steps:

displaying a notification page containing mobile phone change task completion information in the game page when it is monitored that the mobile phone change task is completed during execution of both the mobile phone change task and the game task.

Preferably, the form for displaying the notification page in the game page is a small window form.

Another objective of the embodiments of the present disclosure is to provide an electronic device, comprising: at least one processor; and a memory communicably connected with the at least one processor for storing instructions executable by the at least one processor, wherein execution of the instructions by the at least one processor causes the at least one processor to: start a mobile phone change task when a mobile phone change trigger signal is monitored; display a mobile phone change page; start a game task when a game start trigger signal is monitored during execution of the mobile phone change task; replace the mobile phone change page with a game page containing game content; quit the game task when a game quit trigger signal is monitored during execution of both the mobile phone change task and the game task; and replace the game page with the mobile phone change page.

The electronic device, wherein, if the game quit trigger signal is a temporary game quit trigger signal, the quitting the game task comprises: saving current game information in a local database; and ending the process of the game task; or if the game quit trigger signal is a game task completion trigger signal, the quitting the game task comprises: ending the process of the game task.

The electronic device, wherein, a notification page containing mobile phone change task completion information is displayed in the game page when it is monitored that the mobile phone change task is completed during execution of both the mobile phone change task and the game task.

The electronic device, wherein, the form for displaying the notification page in the game page is a small window form.

A further objective of the embodiments of the present disclosure is to provide a non-transitory computer-readable storage medium storing executable instructions that, when executed by an electronic device, cause the electronic device to: start a mobile phone change task when a mobile phone change trigger signal is monitored; display a mobile phone change page; start a game task when a game start trigger signal is monitored during execution of the mobile phone change task; replace the mobile phone change page with a game page containing game content; quit the game task when a game quit trigger signal is monitored during execution of both the mobile phone change task and the game task; and replace the game page with the mobile phone change page.

The non-transitory computer-readable storage medium, wherein, if the game quit trigger signal is a temporary game quit trigger signal, the quitting the game task comprises: saving current game information in a local database; and ending the process of the game task; or if the game quit trigger signal is a game task completion trigger signal, the quitting the game task comprises: ending the process of the game task.

The non-transitory computer-readable storage medium, wherein, a notification page containing mobile phone change task completion information is displayed in the game page when it is monitored that the mobile phone change task is completed during execution of both the mobile phone change task and the game task.

The non-transitory computer-readable storage medium, wherein, the form for displaying the notification page in the game page is a small window form.

According to the mobile phone change method and the electronic device provided by embodiments of the present disclosure, by monitoring a game start trigger signal during execution of the mobile phone change task, i.e. providing a game start entry during, mobile phone change, the game task, for example, a small game such as Tetris, Snake and the like, can be started when the game start trigger signal is monitored, for example, after it is monitored that the user clicks a game start button, then a kernel-level process will be created by the system to operate the game task, and the mobile phone change task will be automatically transferred to the background to be operated, so that other task operations can be performed during mobile phone change, thereby improving the mobile phone utilization rate, preventing users from having a sense of anxiety because of long waiting time during waiting for mobile phone change, and providing a relaxing and pleasant usage environment for users; in addition, by replacing the mobile phone change page with the game page and displaying the same, the currently displayed page of the mobile phone can be replaced with the game page; and then when quitting the game, by replacing the current page with the mobile phone change page again, the user can replace the current game page with the mobile phone change page at any time when wanting to view the current mobile phone change progress, to view in real time.

According to the mobile phone change method and the electronic device provided by embodiments of the present disclosure, by setting the game quit trigger signal as a temporary game quit trigger signal or a game task completion trigger signal, if the game quit trigger signal is the temporary game quit trigger signal, current game information is saved in a local database, to be invoked next time so as to continue the game. By ending the process of the game task, the occupation rate of useless processes can be reduced, thereby improving the running speed of the mobile phone.

According to the mobile phone change method and the electronic device provided by embodiments of the present disclosure, by displaying the notification page containing mobile phone change task completion information in the game page, if it is monitored that the mobile phone change task is completed during execution of the game task, for example, a monitor is arranged at the background, and when it is monitored that data is transmitted by 100%, it is indicated that the mobile phone change task is completed, then the notification page containing mobile phone change task completion information is displayed in the current game page. For example, a notification can be sent in the form of Toast, to notify the user that data transmission of mobile phone change is completed, thereby providing a free selection for the user to continue the current game or quit the game, and improving the man-machine interaction capability.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a specific example of a mobile phone change method in accordance with embodiment 1 of the present disclosure;

FIG. 2 is a schematic diagram of a specific example of a mobile phone change device in accordance with embodiment 2 of the present disclosure; and

FIG. 3 is a schematic diagram of hardware configuration of an electronic device in accordance with embodiment 4 of the present disclosure, which performs the mobile phone change method.

### DETAILED DESCRIPTION

In order to clearly describe objectives, the technical solutions and advantages of the present disclosure. A clear and complete description of the technical solutions in the present disclosure will be given below, in conjunction with the accompanying drawings in the embodiments of the present disclosure. Apparently, the embodiments described below are a part, but not all, of the embodiments of the present disclosure.

### Embodiment 1

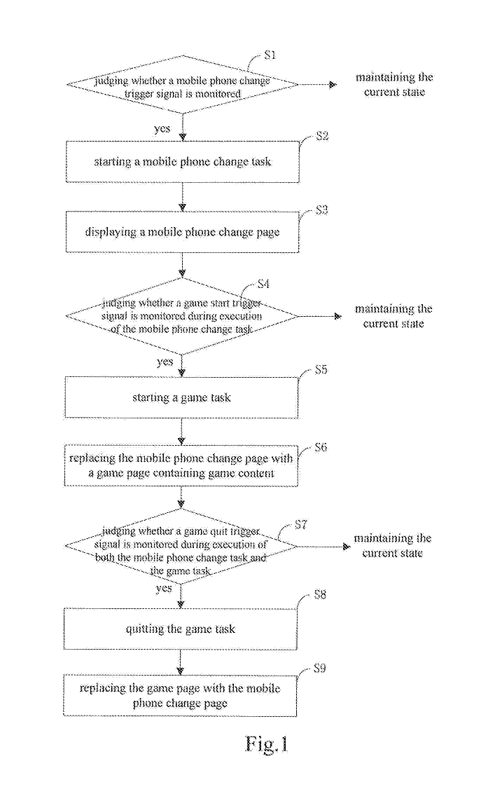

This embodiment provides a mobile phone change method, for example, applied to a mobile terminal (such as a touch-screen mobile phone and the like) comprising a display. As shown in FIG. 1, the mobile phone change method comprises the following steps:

S1. judging whether a mobile phone change trigger signal is monitored; going to step S2 if the mobile phone change trigger signal is monitored; and maintaining the current state if the mobile phone change trigger signal is not monitored, for example, maintaining the state of monitoring the mobile phone change trigger signal;

S2. starting a mobile phone change task;

S3. displaying a mobile phone change page, for example, displaying a mobile phone change page containing mobile phone change progress information, wherein, for example, the mobile phone change page may contain mobile phone change progress information about the percentage of the amount of transmitted data in the total amount of data, estimated remaining time, transmission rate, a transmission content item list and a state corresponding thereto (transmission completed, being sent, waiting and the like);

S4. judging whether a game start trigger signal is monitored during execution of the mobile phone change task; going to step S5 if the game start trigger signal is monitored; and maintaining the current state if the game start trigger signal is not monitored, for example, maintaining the state of monitoring the game start trigger signal, wherein, preferably, a “game start” button can be added on the mobile phone change page, so that the game start trigger signal is monitored when the user clicks the button;

S5. starting a game task (the game task can be started for the first time, and the game task can be restarted after the game task has been quitted previously as well), wherein, for example, the game task can be a small game such as Tetris, Snake and the like, and the game is encapsulated and independently operated in the process, and is equivalent to an independent lightweight disclosure;

S6. replacing the mobile phone change page with a game page containing game content and displaying the same;

S7. judging whether a game quit trigger signal is monitored during execution of both the mobile phone change task and the game task; going to step S8 if the game quit trigger signal is monitored; and maintaining the current state if the game quit trigger signal is not monitored, for example, maintaining the state of monitoring the game quit trigger signal;

S8. quitting the game task; and

S9. replacing the game page with the mobile phone change page and displaying the same.

According to the above-mentioned mobile phone change method, through steps S1-S9, by monitoring the game start trigger signal during execution of the mobile phone change task, i.e. providing a game start entry during mobile phone change, the game task, for example, a small game such as Tetris, Snake and the like can be started when the game start trigger signal is monitored, for example, after it is monitored that the user clicks the game start button, then a kernel-level process will be created by the system to operate the game task, and the mobile phone change task will be automatically transferred to the background to be operated, so that other task operations can be performed during mobile phone change, thereby improving the mobile phone utilization rate, preventing users from having a sense of anxiety because of long waiting time during waiting for mobile phone change, and providing a relaxing and pleasant usage environment for users; in addition, by replacing the mobile phone change page with the game page and displaying the same, the currently displayed page of the mobile phone can be replaced with the game page, and when quitting the game, by replacing the current page with the mobile phone change page again, the user can replace the current game page with the mobile phone change page at any time when wanting to view the current mobile phone change progress, to view in real time.

Preferably, if the game quit trigger signal is a temporary game quit trigger signal, for example, if a user doesn't want to play in the course of playing a game, he/she can click the “return key”, and then a dialog box will be sent to the display window to ask the user whether he/she determines to quit, after the user clicks “Yes”, the temporary game quit trigger signal is generated, the above-mentioned step S8 comprises:

S8-1. saving current game information in a local database; and

S8-2. ending the process of the game task.

Preferably, when the game quit trigger signal is a game task completion trigger signal, for example, after the game of one stage is completed and the game is normally ended, the game task completion trigger signal is generated, the above-mentioned step S8 comprises:

S8-3. ending the process of the game task.

According to the above-mentioned mobile phone change method, by setting the game quit trigger signal as a temporary game quit trigger signal or a game task completion trigger signal, if the game quit trigger signal is the temporary game quit trigger signal, the current game information is saved in a local database, to be invoked next time so as to continue the game; and by ending the process of the game task, the occupation rate of useless processes can be reduced, thereby improving the running speed of the mobile phone.

Preferably, the method further comprises the following steps:

S10. judging whether it is monitored that the mobile phone change task is completed during execution of both the mobile phone change task and the game task; going to step S11 if it is monitored that the mobile phone change task is completed; and maintaining the current state if it is not monitored that the mobile phone change task is completed, for example, maintaining the state of monitoring whether the mobile phone change task is completed; and

S11. displaying a notification page containing mobile phone change task completion information in the game page, wherein, preferably, the form for displaying the notification page in the game page is a small window form, for example, a notification can be sent in the form of Toast, to notify the user that the data transmission of mobile phone change is completed.

According to the above-mentioned mobile phone change method, by displaying the notification page containing mobile phone change task completion information in the game page, if it is monitored that the mobile phone change task is completed during execution of the game task, for example, a monitor is arranged at the background, and when it is monitored that data is transmitted by 100%, it is indicated that the mobile phone change task is completed, then the notification page containing mobile phone change task completion information is displayed in the current game page, thereby providing a free selection for the user to continue the current game or quit the game, and improving the man-machine interaction capability.

### Embodiment 2

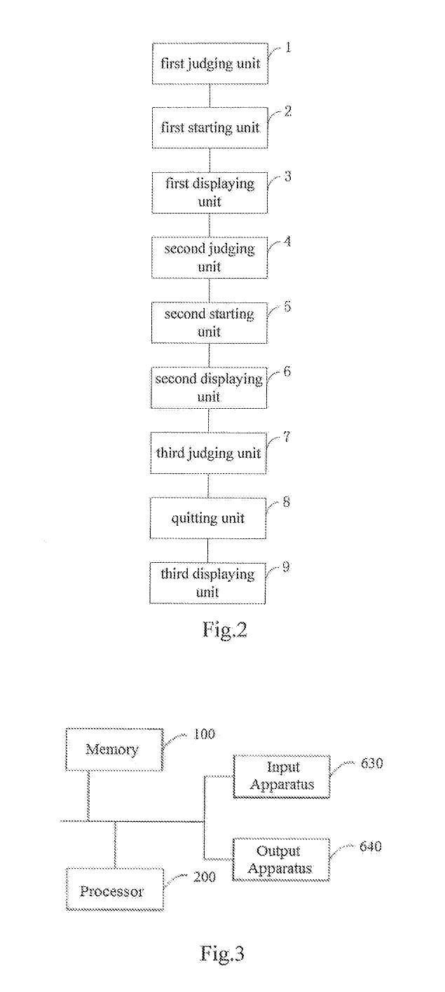

Corresponding to embodiment 1, this embodiment provides a mobile phone change device. As shown in FIG. 2, the mobile phone change device comprises: a first judging unit 1 used for judging whether a mobile phone change trigger signal is monitored; a first starting unit 2 used for starting a mobile phone change task when the mobile phone change trigger signal is monitored; a first displaying unit 3 used for displaying a mobile phone change page, for example, displaying a mobile phone change page containing mobile phone change progress information; a second judging unit 4 used for judging whether a game start trigger signal is monitored during execution of the mobile phone change task; a second starting unit 5 used for starting a game task if the game start trigger signal is monitored; a second displaying unit 6 used for replacing the mobile phone change page with a game page containing game content and displaying the same; a third judging unit 7 used for judging whether a game quit trigger signal is monitored during execution of both the mobile phone change task and the game task; a quitting unit 8 used for quitting the game task if the game quit trigger signal is monitored; and a third displaying unit 9 used for replacing the game page with the mobile phone change page and displaying the same.

According to the above-mentioned mobile phone change device, by monitoring the game start trigger signal during execution of the mobile phone change task, i.e. providing a game start entry during mobile phone change, the game task, for example, a small game such as Tetris, Snake and the like, can be started when the game start trigger signal is monitored, for example, after it is monitored that the user clicks the game start button, then a kernel-level process will be created by the system to operate the game task, and the mobile phone change task will be automatically transferred to the background to be operated, so that other task operations can be performed during mobile phone change, thereby improving the mobile phone utilization rate, preventing users from having a sense of anxiety because of long waiting time during waiting for mobile phone change, and providing a relaxing and pleasant usage environment for users; in addition, by replacing the mobile phone change page with the game page and displaying the same, the currently displayed page of the mobile phone can be replaced with the game page, and when quitting the game, by replacing the current page with the mobile phone change page again, the user can replace the current game page with the mobile phone change page at any time when wanting to view the current mobile phone change progress, to view in real time.

Preferably, if the game quit trigger signal is a temporary game quit trigger signal, the above-mentioned quitting unit 8 comprises: a saving unit used for saving current game information in a local database; and a first ending unit used for ending the process of the game task.

Preferably, if the game quit trigger signal is a game task completion trigger signal, the above-mentioned quitting unit 8 comprises: a second ending unit used for ending the process of the game task.

According to the above-mentioned mobile phone change device, by setting the game quit trigger signal as a temporary game quit trigger signal or a game task completion trigger signal, if the game quit trigger signal is the temporary game quit trigger signal, the current game information is saved in a local database, to be invoked next time so as to continue the game; and by ending the process of the game task, the occupation rate of useless processes can be reduced, thereby improving the running speed of the mobile phone.

Preferably, the above-mentioned mobile phone change device further comprises: a fourth judging unit used for judging whether it is monitored that the mobile phone change task is completed during execution of both the mobile phone change task and the game task; and

a fourth displaying unit used for displaying a notification page containing mobile phone change task completion information in the game page if it is monitored that the mobile phone change task is completed.

According to the above-mentioned mobile phone change device, by displaying the notification page containing mobile phone change task completion information in the game page, if it is monitored that the mobile phone change task is completed during execution, of the game task, for example, a monitor is arranged at the background, and when it is monitored that data is transmitted by 100%, it is indicated that the mobile phone change task is completed, then the notification page containing mobile phone change task completion information is displayed in the current game page, thereby providing a free selection for the user to continue the current game or quit the game, and improving the man-machine interaction capability.

### Embodiment 3

This embodiment provides a non-transitory computer-readable storage medium storing executable instructions that, when executed by an electronic device, cause the electronic device to: start a mobile phone change task when a mobile phone change trigger signal is monitored; display a mobile phone change page; start a game task when a game start trigger signal is monitored during execution of the mobile phone change task; replace the mobile phone change page with a game page containing game content; quit the game task when a game quit trigger signal is monitored during execution of both the mobile phone change task and the game task; and replace the game page with the mobile phone change page.

The non-transitory computer-readable storage medium, wherein, if the game quit trigger signal is a temporary game quit trigger signal, the quitting the game task comprises: saving current game information in a local database; and ending the process of the game task; or if the game quit trigger signal is a game task completion trigger signal, the quitting the game task comprises: ending the process of the game task.

The non-transitory computer-readable storage medium, wherein, a notification page containing mobile phone change task completion information is displayed in the game page when it is monitored that the mobile phone change task is completed during execution of both the mobile phone change task and the game task.

The non-transitory computer-readable storage medium, wherein, the form for displaying the notification page in the game page is a small window form.

### Embodiment 4

FIG. 3 is a schematic diagram of the hardware configuration of the electronic device provided by the embodiment, which performs the mobile phone change method. As shown in FIG. 3, the electronic device includes: one or more processors 200 and a memory 100, wherein one processor 200 is shown in FIG. 3 as an example. The electronic device that performs the mobile phone change method further includes an input apparatus 630 and an output apparatus 640.

The processor 200, the memory 100, the input apparatus 630 and the output apparatus 640 may be connected via a bus line or other means, wherein connection via a bus line is shown in FIG. 3 as an example.

The memory 100 is a non-transitory computer-readable storage medium that can be used to store non-transitory software programs, non-transitory computer-executable programs and modules, such as the program instructions/modules corresponding to the mobile phone change method of the embodiments of the present disclosure (e.g. first judging unit 1, first starting unit 2, first displaying unit 3, second judging unit 4, second starting unit 5, second displaying unit 6, third judging unit 7, quitting unit 8, and third displaying unit 9 shown in the FIG. 2). The processor 200 executes the non-transitory software programs, instructions and modules stored in the memory 100 so as to perform various function application and data processing of the server, thereby implementing the mobile phone change method of the above-mentioned method embodiments

The memory 100 includes a program storage area and a data storage area, wherein, the program storage area can store an operation system and application programs required for at least one function; the data storage area can store data generated by use of the mobile phone change device. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the mobile phone change device via network connection. Examples of the aforementioned network include but not limited to internet, intranet, LAN, GSM, and their combinations.

The input apparatus 630 receives digit or character information, so as to generate signal input related to the user configuration and function control of the mobile phone change device. The output apparatus 640 includes display devices such as a display screen.

The one or more modules are stored in the memory 100 and, when executed by the one or more processors 200, perform the mobile phone change method of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:

1) Mobile communication devices: The characteristic of this type of device is having a mobile communication function with a main goal of enabling voice and data communication. This type of terminal device includes: smartphones (such as iPhone), multimedia phones, feature phones, and low-end phones.

2) Ultra-mobile personal computer devices: This type of device belongs to the category of personal computers that have computing and processing functions and usually also have mobile internet access features. This type of terminal device includes: PDA, MID, UMPC devices, such as iPad.

3) Portable entertainment devices: This type of device is able to display and play multimedia contents. This type of terminal device includes: audio and video players (such as iPod), handheld game players, electronic books, intelligent toys, and portable GPS devices.

4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

What is claimed is:

1. A mobile phone change method, comprising the following steps:
starting a mobile phone change task when a mobile phone change trigger signal is monitored;
displaying a mobile phone change page;
starting a game task when a game start trigger signal is monitored during execution of the mobile phone change task;
replacing the mobile phone change page with a game page containing game content;
quitting the game task when a game quit trigger signal is monitored during execution of both the mobile phone change task and the game task; and
replacing the game page with the mobile phone change page.

2. The mobile phone change method of claim 1, wherein, if the game quit trigger signal is a temporary game quit trigger signal, the quitting the game task comprises: saving current game information in a local database; and ending the process of the game task; or
if the game quit trigger signal is a game task completion trigger signal, the quitting the game task comprises: ending the process of the game task.

3. The mobile phone change method of claim 1, further comprising the following steps:
displaying a notification page containing mobile phone change task completion information in the game page when it is monitored that the mobile phone change task is completed during execution of both the mobile phone change task and the game task.

4. The mobile phone change method of claim 3, wherein, the form for displaying the notification page in the game page is a small window form.

5. An electronic device, comprising:
at least one processor; and
a memory communicably connected with the at least one processor for storing instructions executable by the at least one processor, wherein execution of the instructions by the at least one processor causes the at least one processor to:
start a mobile phone change task when a mobile phone change trigger signal is monitored;
display a mobile phone change page;
start a game task when a game start trigger signal is monitored during execution of the mobile phone change task;
replace the mobile phone change page with a game page containing game content;
quit the game task when a game quit trigger signal is monitored during execution of both the mobile phone change task and the game task; and
replace the game page with the mobile phone change page.

6. The electronic device of claim 5, wherein, if the game quit trigger signal is a temporary game quit trigger signal, the quitting the game task comprises: saving current game information in a local database; and ending the process of the game task; or
if the game quit trigger signal is a game task completion trigger signal, the quitting the game task comprises: ending the process of the game task.

7. The electronic device of claim 5, wherein, a notification page containing mobile phone change task completion information is displayed in the game page when it is monitored that the mobile phone change task is completed during execution of both the mobile phone change task and the game task.

8. The electronic device of claim 7, wherein, the form for displaying the notification page in the game page is a small window form.

9. A non-transitory computer-readable storage medium storing executable instructions that, when executed by an electronic device, cause the electronic device to:
start a mobile phone change task when a mobile phone change trigger signal is monitored;
display a mobile phone change page;
start a game task when a game start trigger signal is monitored during execution of the mobile phone change task;
replace the mobile phone change page with a game page containing game content;
quit the game task when a game quit trigger signal is monitored during execution of both the mobile phone change task and the game task; and
replace the game page with the mobile phone change page.

10. The non-transitory computer-readable storage medium of claim 9, wherein, if the game quit trigger signal is a temporary game quit trigger signal, the quitting the game task comprises: saving current game information in a local database; and ending the process of the game task; or
if the game quit trigger signal is a game task completion trigger signal, the quitting the game task comprises: ending the process of the game task.

11. The non-transitory computer-readable storage medium of claim 9, wherein, a notification page containing mobile phone change task completion information is displayed in the game page when it is monitored that the mobile phone change task is completed during execution of both the mobile phone change task and the game task.

12. The non-transitory computer-readable storage medium of claim 11, wherein, the form for displaying the notification page in the game page is a small window form.
